(19) United States
(12) Patent Application Publication
(10) Pub. No.: US 2024/0125001 A1
(43) Pub. Date: Apr. 18, 2024

(54) ELECTROPLATING BATH WITH SIDE WALLS ENABLING DRAINAGE OF PLATING SOLUTION, AND ELECTROPLATING PRODUCTION LINE

(71) Applicant: CHONGQING JIMAT NEW MATERIAL TECHNOLOGY CO., LTD, Chongqing (CN)

(72) Inventor: Shiwei ZANG, Chongqing (CN)

(73) Assignee: CHONGQING JIMAT NEW MATERIAL TECHNOLOGY CO., LTD, Chongqing (CN)

(21) Appl. No.: 18/505,148

(22) Filed: Nov. 9, 2023

Related U.S. Application Data
(63) Continuation of application No. PCT/CN2023/075601, filed on Feb. 13, 2023.

(30) Foreign Application Priority Data
Oct. 18, 2022 (CN) 202211275729.0

(51) Int. Cl. C25D 17/02; C25D 21/00

(52) U.S. Cl. CPC C25D 17/02; C25D 21/00

(57) ABSTRACT

An electroplating bath includes a bottom plate, and a first side wall and a second side wall arranged oppositely on the bottom plate. The first side wall is provided with a first drainage zone, and the first drainage zone includes a first side plate with a first overflow hole. The second side wall is provided with a second drainage zone, and the second drainage zone includes a second side plate with a second overflow hole. The second side wall is further provided with a plurality of liquid outlet holes communicating with the second drainage zone, and a height of each liquid outlet hole is lower than a height of the first overflow hole and a height of the second overflow hole. The bottom plate is provided with a third drainage zone, and the third drainage zone communicates with the first drainage zone and the second drainage zone.

### CROSS REFERENCE TO THE RELATED APPLICATIONS

This application is the continuation application of International Application No. PCT/CN2023/075601, filed on Feb. 13, 2023, which is based upon and claims priority to Chinese Patent Application No. 202211275729.0, filed on Oct. 18, 2022, the entire contents of which are incorporated herein by reference.

### TECHNICAL FIELD

The present disclosure relates to the technical field of water electroplating, and in particular relates to an electroplating bath with side walls enabling drainage of a plating solution, and an electroplating production line.

### BACKGROUND

With technological development, surface plating of a flexible film substrate is increasingly popular. In industrial production, the flexible film substrate is usually electroplated with a water electroplating device. Specifically, based on various demands of the main body and plating layer, a water plating solution is prepared, such that the flexible film substrate can be electroplated in a short time through the water plating solution.

In the prior art, an electroplating device usually includes a plurality of electroplating baths configured to supply plating solutions. An electroplating bath is an apparatus configured to electroplate a material, where a metal is deposited on the surface of a material to be electroplated based on an electroplating principle, thereby allowing the purpose of electroplating. However, in the prior art, in order to ensure the concentration of a plating solution during electroplating, it is necessary to form a liquid outlet hole and a liquid inlet hole. Currently, the plating solution outlet hole of an electroplating bath is located at the bottom of the electroplating bath. For example, the patent CN114164478A discloses a horizontal electroplating device, where a plating solution outlet hole of the horizontal electroplating device is formed at the bottom of an electroplating bath, making it extremely inconvenient to maintain the plating solution outlet hole.

### SUMMARY

### (I) Technical Problem to be Solved

In view of the shortcomings and deficiencies of the prior art, the present disclosure provides an electroplating bath with side walls enabling drainage of a plating solution, which solves the technical problem that it is inconvenient to maintain a liquid outlet hole formed at a bottom of an electroplating bath in the prior art.

### (II) Technical Solution

To achieve the above objective, the present disclosure adopts the following major technical solutions:

In an aspect, the present disclosure provides an electroplating bath with side walls enabling drainage of a plating solution, including a bottom plate, and a first side wall and a second side wall arranged oppositely on the bottom plate, where the first side wall is provided with a first drainage zone, and the first drainage zone includes a first side plate with a first overflow hole; the second side wall is provided with a second drainage zone, and the second drainage zone includes a second side plate with a second overflow hole; the second side wall is further provided with a plurality of liquid outlet holes communicating with the second drainage zone, and a height of each of the plurality of liquid outlet holes is lower than a height of the first overflow hole and a height of the second overflow hole; and the bottom plate is provided with a third drainage zone, and the third drainage zone communicates with the first drainage zone and the second drainage zone, respectively, and is configured to guide a plating solution in the first drainage zone to the second drainage zone.

Optionally, the electroplating bath further includes a third side wall and a fourth side wall, where the third drainage zone is located on the third side wall, and the third drainage zone, the first drainage zone, and the second drainage zone are arranged in a Π shape on the bottom plate.

Optionally, the plurality of liquid outlet holes are adjacent to the fourth side wall.

Optionally, the third drainage zone, the first drainage zone, and the second drainage zone are arranged in an I shape on the bottom plate.

Optionally, the plurality of liquid outlet holes are located on the second side wall and away from any one or two ends of the third drainage zone.

Optionally, the first overflow hole and the second overflow hole both are strip holes transversely arranged, and are symmetrically arranged on the first side plate and the second side plate, respectively.

Optionally, the second side wall is further provided with a plurality of liquid inlet holes, and the plurality of liquid inlet holes are arranged at two ends of the second side wall.

Optionally, the bottom plate is further provided with one or more liquid inlet pipes, the one or more liquid inlet pipes is/are arranged at two sides of a plating zone and communicate(s) with the second drainage zone, and a side face of the one or more liquid inlet pipes is provided with a plurality of holes.

Optionally, each of the plurality of liquid outlet holes is provided with a liquid outlet valve, and each of the plurality of liquid inlet holes is provided with a liquid inlet valve.

In another aspect, the present disclosure also provides an electroplating production line, including a plurality of the electroplating baths, where the plurality of the electroplating baths are connected sequentially, an anode mechanism is provided inside each electroplating bath, and a liquid inlet pipe at a liquid inlet end of an electroplating bath located at a head end of the electroplating production line abuts against the third drainage zone.

### (III) Beneficial Effects

The present disclosure has the following beneficial effects:

In the electroplating bath with side walls enabling drainage of a plating solution provided by the present disclosure, a plating solution may enter the first drainage zone 21 through the first overflow hole 212 on the first side plate 211 or may enter the second drainage zone 31 through the second overflow hole 312 on the second side plate 311, and a plating solution in the first drainage zone 21 is drained to the second drainage zone 31 through the third drainage zone 11 and then led out through the plurality of liquid outlet holes 32 on the second side wall 3. In the embodiments of the present disclosure, a plating solution overflowed from the first drainage zone 21 is drained to the second drainage zone 31 through the third drainage zone 11 and then discharged, which reduces the arrangement of liquid outlet holes 32 and the maintenance work and allows the outputting of a plating solution from a side face. Compared with the prior art, a liquid outlet hole is formed on a side wall in the present disclosure, which is convenient for maintenance and replacement of a plating solution.

### BRIEF DESCRIPTION OF THE DRAWINGS

FIG. 1 is a schematic diagram of an overall structure of a first electroplating bath in a specific embodiment of the present disclosure;

FIG. 2 is a schematic diagram of an overall structure of a second electroplating bath in a specific embodiment of the present disclosure;

FIG. 3 is a schematic structural diagram of a first side plate and a second side plate in a specific embodiment of the present disclosure;

FIG. 4 is a schematic structural diagram of a first electroplating bath provided with a liquid outlet valve in a specific embodiment of the present disclosure; and

FIG. 5 is a schematic structural diagram of a second electroplating bath provided with a liquid outlet valve in a specific embodiment of the present disclosure.

### REFERENCE NUMERALS

1: bottom plate; 11: third drainage zone; 12: liquid inlet pipe; 13: anode mechanism;
2: first side wall; 21: first drainage zone; 211: first side plate; 212: first overflow hole;
3: second side wall; 31: second drainage zone; 311: second side plate; 312: second overflow hole; 32: liquid outlet hole; 321: liquid outlet valve; 33: liquid inlet hole; 331: liquid inlet valve;
4: third side wall; and
5: fourth side wall.

### DETAILED DESCRIPTION OF THE EMBODIMENTS

In order to facilitate the understanding of the above technical solutions, the exemplary embodiments of the present disclosure are described in detail below with reference to the accompanying drawings. Although the accompanying drawings show exemplary embodiments of the present disclosure, it should be understood that the present disclosure may be implemented in various forms and should not be limited to the embodiments set forth herein. The embodiments are provided to enable the thorough understanding of the present disclosure and to fully convey the scope of the present disclosure to those skilled in the art.

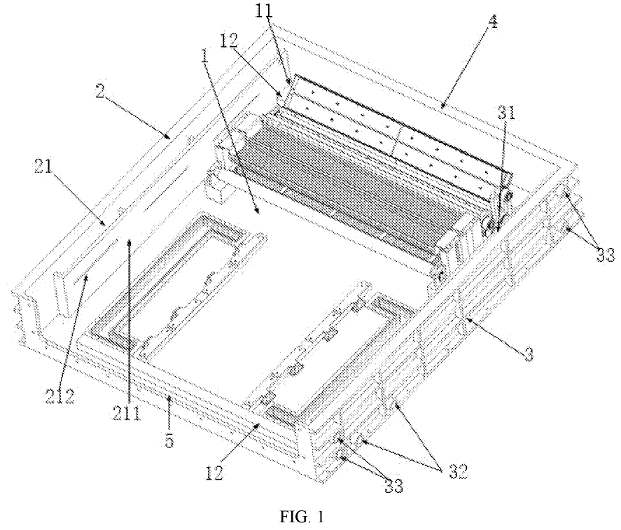

As shown in FIG. 1 to FIG. 3, a specific embodiment of the present disclosure provides an electroplating bath with side walls enabling drainage of a plating solution, including bottom plate 1, and first side wall 2 and second side wall 3 arranged oppositely on the bottom plate 1, where the first side wall 2 is provided with first drainage zone 21, and the first drainage zone 21 includes first side plate 211 with first overflow hole 212; the second side wall 3 is provided with second drainage zone 31, and the second drainage zone 31 includes second side plate 311 with second overflow hole 312; the second side wall 3 is further provided with a plurality of liquid outlet holes 32 communicating with the second drainage zone 31, and a height of each of the plurality of liquid outlet holes 32 is lower than a height of the first overflow hole 212 and a height of the second overflow hole 312; and the bottom plate 1 is provided with third drainage zone 11, and the third drainage zone 11 communicates with the first drainage zone 21 and the second drainage zone 31, respectively, and is configured to guide a plating solution in the first drainage zone 21 to the second drainage zone 31.

Specifically, a plating solution may enter the first drainage zone 21 through the first overflow hole 212 on the first side plate 211 or may enter the second drainage zone 31 through the second overflow hole 312 on the second side plate 311, and a plating solution in the first drainage zone 21 is drained to the second drainage zone 31 through the third drainage zone 11 and then led out through the plurality of liquid outlet holes 32 on the second side wall 3. In this embodiment of the present disclosure, a plating solution overflowed from the first drainage zone 21 is drained to the second drainage zone 31 through the third drainage zone 11 and then discharged, which reduces the arrangement of liquid outlet holes 32 and the maintenance work, allows the outputting of a plating solution from a side face, and is convenient for maintenance and replacement of a plating solution.

As shown in FIG. 1, in some embodiments, the electroplating bath further includes third side wall 4 and fourth side wall 5. It should be noted that, when an electroplating device includes one electroplating bath, the electroplating bath has the third side wall 4 and the fourth side wall 5; and when the electroplating device includes a plurality of electroplating baths, the plurality of electroplating baths are connected end-to-end, an electroplating bath located at a head end of the electroplating device has the third side wall 4, an electroplating bath located at a tail end of the electroplating device has the fourth side wall 5, and an electroplating bath in the middle has the first side wall 2 and the second side wall 3.

Specifically, when the electroplating device includes one electroplating bath, the third drainage zone 11 is located on the third side wall 4, and the third drainage zone 11, the first drainage zone 21, and the second drainage zone 31 are arranged in a H shape on the bottom plate 1. In this case, the plurality of liquid outlet holes 32 are adjacent to the fourth side wall 5.

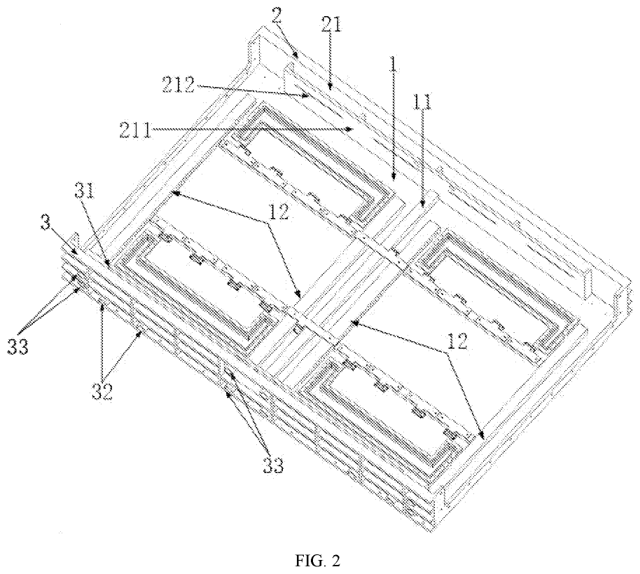

As shown in FIG. 2, in some embodiments, when the electroplating device includes a plurality of electroplating baths, an electroplating bath between first and last electroplating baths only has the first side wall 2 and the second side wall 3, and the third drainage zone 11, the first drainage zone 21, and the second drainage zone 31 are arranged in an I shape on the bottom plate 1. In this case, the plurality of liquid outlet holes 32 are located on the second side wall 3 and away from any one or two ends of the third drainage zone 11.

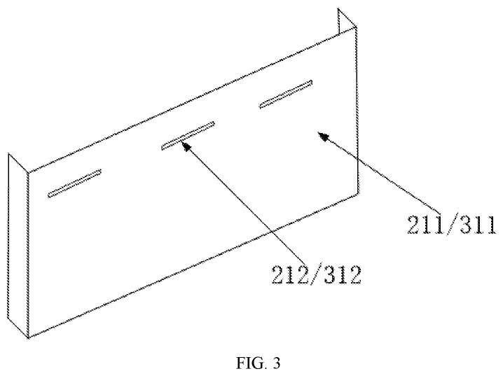

As shown in FIG. 3, in some embodiments, the first overflow hole 212 and the second overflow hole 312 both are strip holes transversely arranged, and are symmetrically arranged on the first side plate 211 and the second side plate 311, respectively. During electroplating, a film is flush with the first overflow hole 212 and the second overflow hole 312, which facilitates the outputting of a plating solution under the film. In this embodiment of the present disclosure, the symmetrical arrangement of the first overflow hole 212 and the second overflow hole 312 on the first side plate 211 and the second side plate 311 respectively can make left and right ends in the electroplating bath balanced in terms of plating solution outputting.

As shown in FIG. 1 and FIG. 2, in some embodiments, the second side wall 3 is further provided with a plurality of liquid inlet holes 33, and the plurality of liquid inlet holes 33 are arranged at two ends of the second side wall 3. In this embodiment of the present disclosure, the arrangement of the plurality of liquid inlet holes 33 at the two ends of the second side wall 3 can make front and rear ends in the electroplating bath balanced in terms of plating solution inputting.

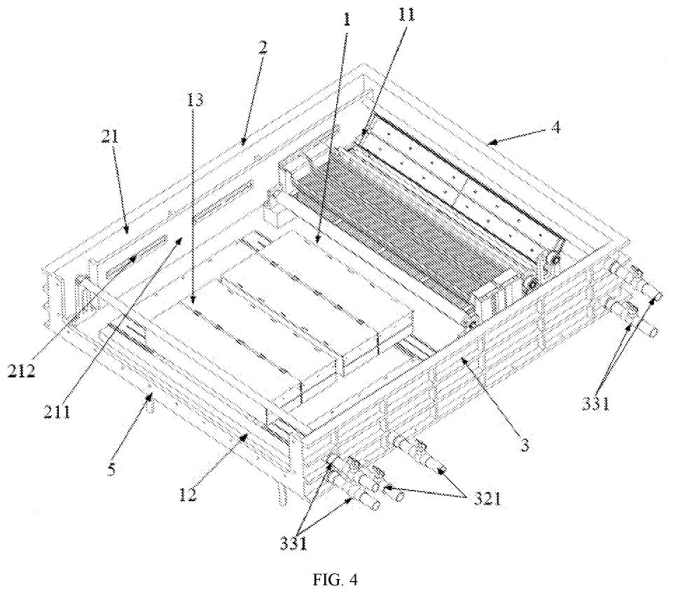

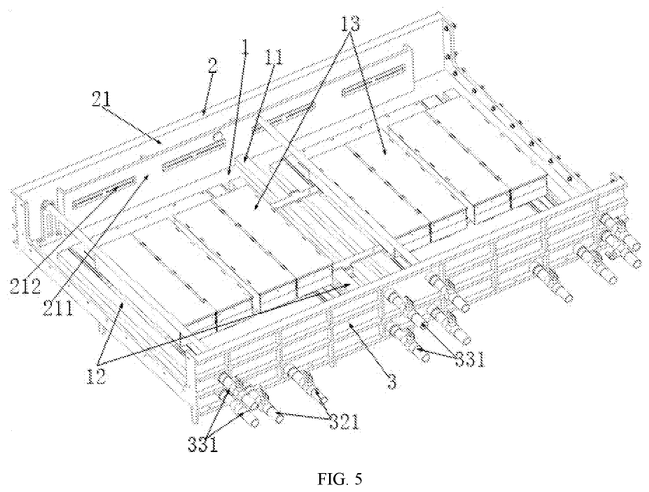

As shown in FIG. 4 and FIG. 5, in some embodiments, the bottom plate 1 is further provided with one or more liquid inlet pipes 12, the one or more liquid inlet pipes 12 is/are arranged at two sides of a plating zone and communicate(s) with the second drainage zone 31, and a side face of the one or more liquid inlet pipes 12 is provided with a plurality of holes. It should be noted that, when the electroplating device includes one electroplating bath, a liquid inlet pipe 12 is arranged at each of a liquid inlet end and a liquid outlet end of the electroplating bath, and a liquid inlet pipe 12 located at the liquid inlet end abuts against the third drainage zone 11, which allows a compact structure of the electroplating bath and reduces a floor space of the electroplating bath. Of course, when the electroplating device includes a plurality of electroplating baths, a liquid inlet pipe 12 at a liquid inlet end of an electroplating bath located at a head end also abuts against the third drainage zone 11.

Thus, the arrangement of the liquid inlet pipe 12 at each of two sides of the plating zone in the electroplating bath and the slow inputting through the plurality of holes on the side face of the liquid inlet pipe 12 not only ensures that plating solution densities at various parts in the electroplating bath remain consistent, but also prevents a film from being unstable in a plating solution due to excessive plating solution inputting, which affects a quality of a coated film.

As shown in FIG. 4 and FIG. 5, each of the plurality of liquid outlet holes 32 is provided with a liquid outlet valve 321, and each of the plurality of liquid inlet holes 33 is provided with a liquid inlet valve 331. In an embodiment of the present disclosure, the outputting and inputting of a plating solution of an electroplating device may be controlled through the liquid outlet valve 321 and the liquid inlet valve 331 at any time.

The present disclosure also provides an electroplating production line, including a plurality of the electroplating baths, where the plurality of the electroplating baths are connected sequentially, anode mechanism 13 is provided inside each electroplating bath, and liquid inlet pipe 12 at a liquid inlet end of an electroplating bath located at a head end of the electroplating production line abuts against the third drainage zone 11. The electroplating production line in this embodiment of the present disclosure can allow the outputting of a plating solution from a side face, reduce the arrangement of liquid outlet holes 32 and the maintenance work, and is convenient for maintenance and replacement of a plating solution. In addition, the electroplating production line of the present disclosure has a compact structure, a reasonable design, and a small floor space.

The present disclosure has the following beneficial effects:

In the electroplating bath of the present disclosure, a plating solution overflowed from the first drainage zone 21 is drained to the second drainage zone 31 through the third drainage zone 11 and then discharged, which reduces the arrangement of liquid outlet holes 32 and the maintenance work, allows the outputting of a plating solution from a side face, and is convenient for maintenance and replacement of a plating solution.

In the electroplating bath of the present disclosure, the symmetrical arrangement of the first overflow hole 212 and the second overflow hole 312 on the first side plate 211 and the second side plate 311 respectively can make left and right ends in the electroplating bath balanced in terms of plating solution outputting.

In the electroplating bath of the present disclosure, the arrangement of the plurality of liquid inlet holes 33 at the two ends of the second side wall 3 can make front and rear ends in the electroplating bath balanced in terms of plating solution inputting.

In the electroplating bath of the present disclosure, the arrangement of the liquid inlet pipe 12 at each of two sides of the plating zone in the electroplating bath and the slow inputting through the plurality of holes on the side face of the liquid inlet pipe 12 not only ensures that plating solution densities at various parts in the electroplating bath remain consistent, but also prevents a film from being unstable in a plating solution due to excessive plating solution inputting, which affects a quality of a coated film.

In the electroplating bath of the present disclosure, the outputting and inputting of a plating solution of an electroplating device may be controlled through the liquid outlet valve 321 and the liquid inlet valve 331 at any time.

It should be understood that in the description of the present disclosure, terms such as “first” and “second” are used merely for the purpose of description, and should not be construed as indicating or implying relative importance, or implicitly indicating the number of technical features denoted. Thus, features defined with “first” and “second” may explicitly or implicitly include one or more of the features. In the description of the present disclosure, “a plurality of” means two or more, unless otherwise specifically defined.

In the present disclosure, unless otherwise clearly specified, the terms such as “arrangement”, “interconnection”, “connection” and “fixation” are intended to be understood in a broad sense. For example, the “connection” may be a fixed connection, removable connection, or integral connection; may be a mechanical connection or electrical connection; may be a direct connection or indirect connection through an intermediate medium; and may be a communication or interaction between two elements. Those of ordinary skill in the art may understand specific meanings of the above terms in the present disclosure based on specific situations.

In the present disclosure, unless otherwise explicitly specified, when it is described that a first feature is “above” or “below” a second feature, it indicates that the first and second features are in direct contact or the first and second features are in indirect contact through an intermediate medium. In addition, when it is described that the first feature is “over”, “above”, and “on” the second feature, it indicates that the first feature is directly or obliquely above the second feature, or simply indicates that the first feature is higher than the second feature. When it is described that a first feature is “under”, “below”, or “beneath” a second feature, it indicates that the first feature is directly or obliquely under the second feature or simply indicates that a horizontal height of the first feature is lower than a horizontal height of the second feature.

In the description of this specification, the description with reference to the terms such as “one embodiment”, “some embodiments”, “example”, “specific example”, or “some examples” means that specific features, structures, materials, or characteristics described in connection with the embodiment or example are included in at least one embodiment or example of the present disclosure. In this specification, the schematic expression of the above terms is not necessarily directed to the same embodiment or example. Moreover, the specific features, structures, materials, or characteristics described may be combined in a suitable manner in any one or more embodiments or examples. In addition, those skilled in the art may combine different embodiments or examples described in this specification and characteristics of the different embodiments or examples without any contradiction.

Although the embodiments of the present disclosure have been illustrated and described above, it will be appreciated that the above embodiments are illustrative and should not be construed as limiting the present disclosure. Changes, modifications, substitutions, and variations can be made to the above embodiments by a person of ordinary skill in the art within the scope of the present disclosure.

What is claimed is:

1. An electroplating bath with side walls enabling drainage of a plating solution, comprising:
a bottom plate, and a first side wall and a second side wall arranged oppositely on the bottom plate, wherein
the first side wall is provided with a first drainage zone, and the first drainage zone comprises a first side plate with a first overflow hole;
the second side wall is provided with a second drainage zone, and the second drainage zone comprises a second side plate with a second overflow hole;
the second side wall is further provided with a plurality of liquid outlet holes communicating with the second drainage zone, and a height of each of the plurality of liquid outlet holes is lower than a height of the first overflow hole and a height of the second overflow hole; and
the bottom plate is provided with a third drainage zone; and the third drainage zone communicates with the first drainage zone and the second drainage zone, respectively, and the third drainage zone is configured to guide a plating solution in the first drainage zone to the second drainage zone.

2. The electroplating bath according to claim 1, further comprising:
a third side wall and a fourth side wall, wherein
the third drainage zone is located on the third side wall, and the third drainage zone, the first drainage zone, and the second drainage zone are arranged in a Π shape on the bottom plate.

3. The electroplating bath according to claim 2, wherein
the plurality of liquid outlet holes are adjacent to the fourth side wall.

4. The electroplating bath according to claim 1, wherein
the third drainage zone, the first drainage zone, and the second drainage zone are arranged in an I shape on the bottom plate.

5. The electroplating bath according to claim 4, wherein
the plurality of liquid outlet holes are located on the second side wall and away from any one or two ends of the third drainage zone.

6. The electroplating bath according to claim 1, wherein
the first overflow hole and the second overflow hole are strip holes transversely arranged, and the first overflow hole and the second overflow hole are symmetrically arranged on the first side plate and the second side plate, respectively.

7. The electroplating bath according to claim 1, wherein
the second side wall is further provided with a plurality of liquid inlet holes, and the plurality of liquid inlet holes are arranged at two ends of the second side wall.

8. The electroplating bath according to claim 7, wherein
the bottom plate is further provided with liquid inlet pipes, the liquid inlet pipes are arranged at two sides of a plating zone and communicate with the second drainage zone, and a side face of each of the liquid inlet pipes is provided with a plurality of holes.

9. The electroplating bath according to claim 7, wherein
each of the plurality of liquid outlet holes is provided with a liquid outlet valve, and each of the plurality of liquid inlet holes is provided with a liquid inlet valve.

10. An electroplating production line, comprising a plurality of the electroplating baths according to claim 1, wherein
the plurality of the electroplating baths are connected sequentially, an anode mechanism is provided inside each of the plurality of the electroplating baths, and a liquid inlet pipe at a liquid inlet end of an electroplating bath located at a head end of the electroplating production line abuts against the third drainage zone.

11. The electroplating production line according to claim 10, wherein
the electroplating bath further comprises a third side wall and a fourth side wall, wherein
the third drainage zone is located on the third side wall, and the third drainage zone, the first drainage zone, and the second drainage zone are arranged in all shape on the bottom plate.

12. The electroplating production line according to claim 11, wherein
the plurality of liquid outlet holes are adjacent to the fourth side wall.

13. The electroplating production line according to claim 10, wherein
the third drainage zone, the first drainage zone, and the second drainage zone are arranged in an I shape on the bottom plate.

14. The electroplating production line according to claim 13, wherein
the plurality of liquid outlet holes are located on the second side wall and away from any one or two ends of the third drainage zone.

15. The electroplating production line according to claim 10, wherein
the first overflow hole and the second overflow hole are strip holes transversely arranged, and the first overflow hole and the second overflow hole are symmetrically arranged on the first side plate and the second side plate, respectively.

16. The electroplating production line according to claim 10, wherein
the second side wall is further provided with a plurality of liquid inlet holes, and the plurality of liquid inlet holes are arranged at two ends of the second side wall.

17. The electroplating production line according to claim 16, wherein
the bottom plate is further provided with liquid inlet pipes, the liquid inlet pipes are arranged at two sides of a plating zone and communicate with the second drainage zone, and a side face of each of the liquid inlet pipes is provided with a plurality of holes.

18. The electroplating production line according to claim 16, wherein
each of the plurality of liquid outlet holes is provided with a liquid outlet valve, and each of the plurality of liquid inlet holes is provided with a liquid inlet valve.
